(19) United States
(12) Patent Application Publication
(10) Pub. No.: US 2004/0112695 A1
(43) Pub. Date: Jun. 17, 2004

(54) Hydraulic shock absorber

(75) Inventors: Takahiro Niwa, Inuyama-Shi (JP); Takeshi Shindo, Inuyama-Shi (JP); Kotaro Kashiyama, Inuyama-Shi (JP)

Correspondence Address: RADER, FISHMAN & GRAUER PLLC, 39533 WOODWARD AVENUE, SUITE 140, BLOOMFIELD HILLS, MI, 48304-0610, US

(73) Assignee: Daido Metal Company Ltd.

(21) Appl. No.: 10/729,448

(22) Filed: Dec. 5, 2003

(30) Foreign Application Priority Data
Dec. 6, 2002 (JP) 2002-355062

(51) Int. Cl. F16F 9/36

(52) U.S. Cl. 188/322.17

(57) ABSTRACT

The invention provides a hydraulic shock absorber which can satisfy a demand of weight saving for a rod guide and can reduce a manufacturing cost. Since a rod guide is constituted by a press molded product formed by press molding a sheet member, and at least a sliding surface of the rod guide with respect to a piston rod is coated with a sliding synthetic resin layer, it is possible to achieve a widely weight saving in comparison with the case of using a metal sintered housing, it is possible to secure a sufficient rigidity in comparison with the case that an entire of the rod guide is formed by a synthetic resin for sliding, and it is possible to achieve a further weight saving in comparison with the structure in which a composite sliding member is pressed.

### CROSS-REFERENCE TO RELATED APPLICATIONS

This application claims priority based on Japanese Patent Application No. 2002-355062, filed Dec. 6, 2002, the entirety of which is incorporated herein by reference.

### BACKGROUND OF THE INVENTION

1. Field of the Invention

The present invention relates to a hydraulic shock absorber having a rod guide for guiding a piston rod provided in an end portion of a cylinder and sliding within the cylinder.

2. Description of the Prior Art

In conventional, in a hydraulic shock absorber used in a motor vehicle or the like, a structure in which a composition resin sliding member constituted by a three-layer structure comprising a steel back metal layer, a porous intermediate layer and a resin surface layer is pressed into a sliding surface of a metal sintered housing with respect to a piston rod is mainly used as a rod guide for guiding the piston rod sliding within the cylinder. However, a combination of the sintered housing and the composite resin sliding member has a problem in connection with a recent demand of weight saving in view of a weight, a manufacturing cost and the like. Accordingly, in recent years, as shown in JP-A-7-332422, there is going to be proposed a rod guide structured such that the composite resin sliding member mentioned above is pressed into a press molded product manufactured by press molding a sheet member. Further, in response to the demand of weight saving, there can be considered a structure in which an entire of the rod guide is formed by a synthetic resin for sliding.

However, in the case that the entire of the rod guide is formed by the synthetic resin for sliding, the rod guide is inferior in a rigidity, and a problem exists in a durability. Further, the structure in which the composite resin sliding member is pressed into the press molded product has no problem in view of the rigidity, however, since it is necessary to independently manufacture the press molded product and the composite resin sliding member so as to assemble them, there are problems that a manufacturing cost is increased and a demand of further weight saving exists. The present invention is made by taking the matters mentioned above into consideration, and an object of the present invention is to provide a hydraulic shock absorber which can satisfy a demand of weight saving for a rod guide and can reduce a manufacturing cost.

### SUMMARY OF THE INVENTION

In order to achieve the object mentioned above, in accordance with a first aspect of the present invention, there is provided a hydraulic shock absorber having a rod guide for guiding a piston rod provided in an end portion of a cylinder and sliding within the cylinder, wherein the rod guide is constituted by a press molded product formed by press molding a sheet member, and at least a sliding surface of the rod guide with respect to the piston rod is coated with a sliding synthetic resin layer. In accordance with the structure mentioned above, since the rod guide is constituted by the press molded product formed by press molding the sheet member, and at least the sliding surface of the rod guide with respect to the piston rod is coated with the sliding synthetic resin layer, it is possible to achieve a widely weight saving in comparison with the case of using the sintered housing, it is possible to secure a sufficient rigidity in comparison with the case that the entire of the rod guide is formed by the synthetic resin for sliding, and it is possible to achieve a further weight saving in comparison with the structure in which the composite sliding member is pressed.

Further, in accordance with a second aspect of the present invention, there is provided a hydraulic shock absorber as recited in the first aspect, wherein the sliding synthetic resin layer is formed by outsert molding the sliding synthetic resin in the press molded product. In accordance with the structure mentioned above, it is possible to manufacture the rod guide with the resin easily and inexpensively.

Further, in accordance with a third aspect of the present invention, there is provided a hydraulic shock absorber as recited in the first aspect, wherein the sliding synthetic resin layer is formed by coating the sliding synthetic resin on the press molded product. In accordance with the structure mentioned above, it is possible to manufacture the rod guide with the resin easily and inexpensively.

### BRIEF DESCRIPTION OF THE DRAWINGS

FIG. 1 is a cross sectional view showing an inner portion of a hydraulic shock absorber;

FIG. 2 is a cross sectional view showing an upper portion of the hydraulic shock absorber to which a rod guide in accordance with an embodiment is mounted; and

FIG. 3 is a cross sectional view of the rod guide in accordance with the embodiment.

### DESCRIPTION OF THE PREFERRED EMBODIMENT

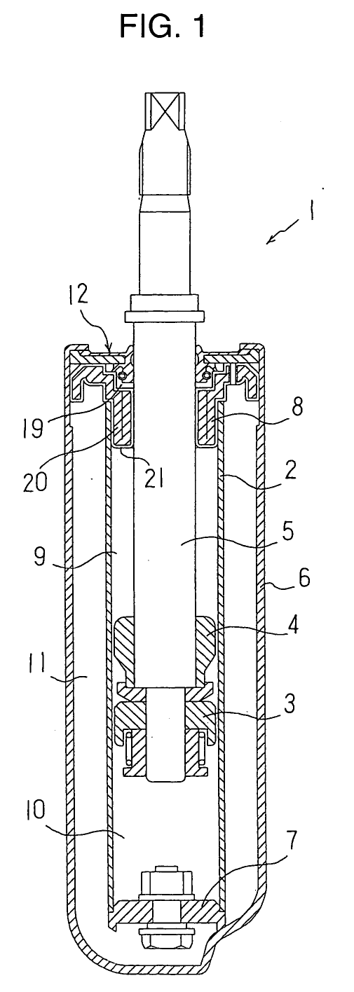

A description will be given below of an embodiment in accordance with the present invention with reference to the accompanying drawings. First, a description will be given of an outline of a hydraulic shock absorber 1 in accordance with the present embodiment, with reference to FIG. 1. FIG. 1 is a cross sectional view showing an inner portion of the hydraulic shock absorber 1.

In FIG. 1, the hydraulic shock absorber 1 is constituted by a cylinder 2 in which an oil for a shock absorber is charged, a piston rod 5 sliding within the cylinder 2, a piston 3 attached to one end of the piston rod 5, a rod guide 8 provided in an end portion of the cylinder 2 and guiding a sliding operation of the piston rod 5, a rebound stopper 4 provided in the piston rod 5 and brought into contact with the rod guide 8 at a time when the piston rod 5 reaches a stroke end in an expanding side, an outer tube 6 constructing an outer shape of the hydraulic shock absorber 1, and a base 7 mounted to a bottom portion of the cylinder 2.

As shown in FIG. 1, the hydraulic shock absorber 1 is structured by a double structure constituted by the cylinder 2 which is closed in an upper side by the rod guide 8 and is closed in a lower side by the base 7, and the outer tube 6 which covers the cylinder 2 from an outer side, and is closed in an upper side by an oil seal 12. A reservoir chamber 11 is formed between the cylinder 2 and the outer tube 6, and a low pressure nitrogen gas or the like corresponding to an inert gas is charged in an inner portion of the reservoir chamber 11. An oil for a shock absorber is charged in an inner portion of the cylinder 2, the piston 3 mounted to a leading end of the piston rod 5 is slidably fitted to the inner portion of the cylinder 2, and the inner side of the cylinder 2 is sectioned into an upper liquid chamber 9 and a lower liquid chamber 10 by this piston 3. The lower liquid chamber 10 is communicated with a lower portion of the reservoir chamber 11 via a communication passage (not shown). Further, an orifice (not shown) is formed in the piston 3, and the oil within the cylinder 2 passes through the orifice in the case that the piston 3 slides within the cylinder 2. Accordingly, a vibration of the piston 3 is damped by a flow resistance generated at a time when the oil passes through the orifice.

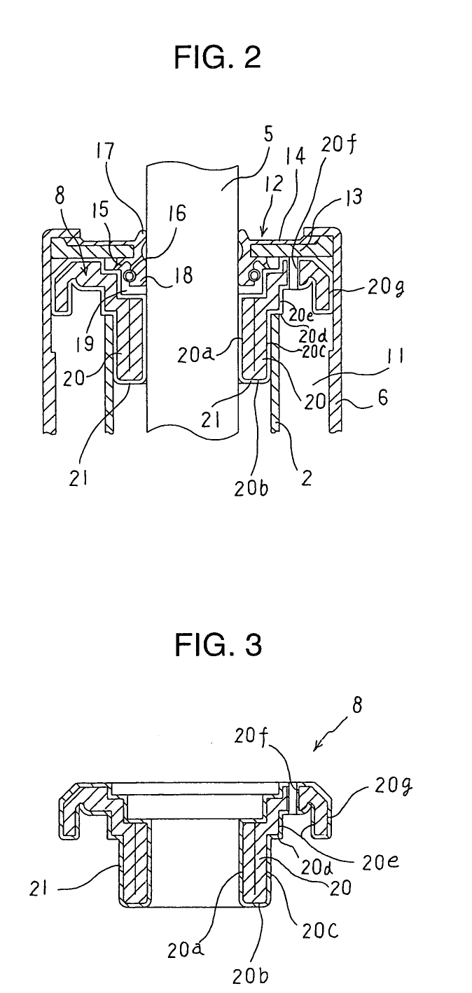

Next, a description will be given of the rod guide 8 constituting a main portion of the present embodiment with reference to FIGS. 2 and 3. FIG. 2 is a cross sectional view showing an upper portion of the hydraulic shock absorber 1 to which the rod guide 8 in accordance with the embodiment is mounted, and FIG. 3 is a cross sectional view of the rod guide 8.

In FIGS. 2 and 3, the rod guide 8 is constituted by a press molded product 20 formed by press molding a sheet material capable of being deep drawn (for example, SPCD material or the like), and is formed by coating an outer peripheral surface including the sliding surface with respect to the piston rod 5 with a sliding synthetic resin layer 21. A description will be in detail given below of the press molded product 20 and the sliding synthetic resin layer 21.

First, the press molded product 20 formed by the press molding is press molded in such a shape that the piston rod 5 penetrates through the press molded product and the press molded product closes an upper end of the outer tube. In particular, the press molded product 20 is formed in such a manner as to have a sliding surface 20a brought into contact with the outer periphery of the piston rod 5, a stopper contact surface 20b bent horizontally toward an outer side of a lower end portion of the sliding surface 20a and brought into contact with the rebound stopper 4, a cylinder contact surface 20c risen from an outer end portion of the stopper contact surface 20b in a state of being back on to the sliding surface 20a and brought into contact with an inner peripheral surface of the cylinder 2, a cylinder contact step portion 20d extended from the cylinder contact surface 20c toward a horizontally outer side and brought into contact with the upper end portion of the cylinder 2, a depression surface 20e continuously provided from an outer end portion of the cylinder contact step portion 20d in a downward C shape and corresponding to an upper end portion of the reservoir chamber 11, and an outer tube contact surface 20g forming an outer surface of an outer end line of the depression surface 20e and brought into contact with an inner peripheral surface of the outer tube 6. In this case, oil returning holes 20f penetrating in a vertical direction are provided at a plurality of positions (three positions, although a detailed description is omitted) on the depression surface 20e.

The sliding synthetic resin layer 21 coating the outer peripheral surface of the press molded product 20 structured as mentioned above is formed by a sliding synthetic resin with a predetermined thickness. The sliding synthetic resin is constituted by a material based on a polyphenylene sulfide (hereinafter, refer simply to “PPS”), a polyether ether ketone (hereinafter, refer simply to “PEEK”) and a polyamide (hereinafter, refer simply to “PA”) which are thermoplastic resins, and a phenol (hereinafter, refer simply to “PF”) and a polyamide imide (hereinafter, refer simply to “PAI”) which are thermosetting resins, and containing any one or some of a molybdenum disulfide (hereinafter, refer simply to “MoS₂”), a carbon fiber (hereinafter, refer simply to “CF”), a potassium titanate fiber (hereinafter, refer simply to “whisker”), a graphite (hereinafter, refer simply to “Gr”), a polytetrafluoroethylene (hereinafter, refer simply to “PTFE”), a tetrafluoroethylene perfluoro alkyl vinyl ether copolymer (hereinafter, refer simply to “PFA”) and the like, as a filler for the base resin. Further, a method of coating the sliding synthetic resin includes a method of forming the sliding synthetic resin layer 21 by outsert molding the sliding synthetic resin on the press molded product 20, and a method of forming the sliding synthetic resin layer 21 by coating the sliding synthetic resin on the press molded product 20.

In accordance with the outsert molding method, the sliding synthetic resin layer 21 can be obtained by fixing the press molded product 20 to a metal mold of an injection molding machine and thereafter injection molding the molten sliding synthetic resin into the metal mold. In the case that the PPS resin is used as the base resin, it is desirable that the injection molding is performed under a condition that a temperature of the metal mold is, for example, 125° C. and a cylinder temperature is 300° C., and the obtained sliding synthetic resin layer 21 has a thickness of 0.5 mm or more.

On the other hand, the coating method can employ various methods such as an air spray method, a dipping method, a printing method and the like. For example, in the case of coating in accordance with the air spray method, the method is executed by the following steps of degreasing the press molded product 20, subsequently roughening the surface in accordance with a blast treatment, an etching treatment, a machining or the like, preparing a liquid resin composition constituted by dissolving the sliding synthetic resin into an appropriate organic solvent, a dimethyl acetamide (DMAC), a methyl ethyl ketone (MEK), an n-methyl 2-pyrrolidone (NMP) or the like while applying a pretreatment of removing impurities attached on the surface by performing an acid cleaning, attaching the press molded product 20 to which the pretreatment mentioned above is applied to a cylindrical jig so as to attach to a turn table, and applying the liquid resin composition mentioned above by an air spray while rotating at 300 rpm or more. In this case, it is desirable to attach the jig in a state of attaching the press molded product 20 to the turn table after heating to a temperature between 40 and 150° C. Further, when drying and sintering the press molded product 20 with the coating layer after passing through the coating step mentioned above at a temperature between 150 and 400° C., the solvent is evaporated, the coating layer containing the base resin and the filler is hardened, and the sliding synthetic resin layer 21 is formed on an outer peripheral surface of the press molded product 20. The obtained sliding synthetic resin layer 21 has a thickness of application between 5 and 200 μm.

In this case, in either the outsert molding method or the coating method, since the work can be easily executed by coating an entire of the outer surface of the press molded product 20 with the sliding synthetic resin layer, the structure in which the entire of the outer surface is coated is shown as the embodiment in the description mentioned above, however, it is sufficient that at least only the sliding surface 20a is coated with the sliding synthetic resin.

Accordingly, as shown in FIG. 2, the rod guide 8 is mounted to the cylinder 2 by inserting the cylinder contact surface 20c and the outer tube contact surface 20g to the cylinder 2 and the outer tube 6 respectively so as to press into a position where the lower surface side of the cylinder contact step portion 20d is brought into contact with an upper end surface of the cylinder 2. The sliding motion of the piston rod 5 is guided by the sliding surface 20a owing to the rod guide 8 mounted in the manner mentioned above.

An oil seal 12 constituted by a seal main body 13 and a seal member 14 is provided in an upper side of the rod guide 8. The seal main body 13 is formed in an annular shape in a state in which a hole is pierced in a center thereof, and the seal member 14 is formed by an elastic member such as a rubber or the like and is mounted to an inner periphery and upper and lower surface of the seal main body 13. A sealing upper lip 17 and a sealing lower rip 18 which are closely attached to the inserted piston rod 5 are formed in upper and lower sides of an inner peripheral surface of the seal member 14. Further, a spring member 16 for sealing the oil by closely attaching the sealing lower lip 18 to the piston rod 5 is mounted to an outer periphery of the sealing lower lip 18. Further, a checking lip 15 is protruded downward in an outer periphery of the sealing lower lip 18.

Accordingly, the oil seal 12 is mounted to the outer tube 6 by folding and caulking the upper end surface of the outer tube 6 toward the piston rod 5 as shown in FIG. 2 after inserting the outer periphery of the seal main body 13 into the outer tube 6 so as to press the oil seal 12 until the lower surface of the seal main body 13 is brought into contact with the upper end of the rod guide 8. At this time, the checking lip 15 of the seal member 14 is brought into contact with the upper surface of the cylinder contact step portion 20d of the rod guide 8, and an upper chamber 19 is formed between the oil seal 12 and the rod guide 8. The oil ascended after passing through a gap between the piston rod 5 and the sliding surface 20a enters into the upper chamber 19 from the upper liquid chamber 9. When the pressure of the oil within the upper chamber 19 becomes high, the oil elastically deforms the checking lip 15 so as to make the oil within the upper chamber 19 to pass through. The oil passing while elastically deforming the checking lip 15 is returned to the reservoir chamber 11 through the oil returning holes 20f formed in the rod guide 8.

Accordingly, in the hydraulic shock absorber 1 having the structure mentioned above, when the piston rod 5 moves upward, the rebound stopper 4 is brought into contact with the rod guide 8 as shown in FIG. 2, thereby limiting a further upward movement of the piston rod 5. In other words, a position where the rebound stopper 4 is brought into contact with the rod guide 8 is a stroke end in an expanding direction of the piston rod 5. Further, the piston rod 5 moves in a vertical direction in accordance with a sliding movement on the sliding synthetic resin layer 21 coated on the sliding surface 20a of the rod guide 8.

Next, a description will be given of test results performed by comparing the rod guide 8 in which the outer peripheral surface of the press molded product 20 is coated with the sliding synthetic resin layer 21 in accordance with the embodiment of the present invention, with the conventionally used rod guide, with reference to Tables 1 and 2.

TABLE 1

| | Sliding synthetic resin layer | Press molded | Abrasion |
|---|---|---|---|
| | component (volume %) | product | loss (μm) |
| Embodiment 1 | PPS + 10 CF + 5 PTFE | Yes | 18 |
| Embodiment 2 | PEEK + 5 whisker + 10 | Yes | 10 |
| | PTFE | | |
| Embodiment 3 | PA + 5 CF + 10 MoS₂ | Yes | 23 |
| Embodiment 4 | PF + 10 Gr + 5 CF | Yes | 29 |
| Comparative | PPS + 10 CF + 5 PTFE | No | 80 |
| embodiment 1 | | | |
| Comparative | PEEK + 5 whisker + 10 | No | 51 |
| embodiment 2 | PTFE | | |
| Comparative | PA + 5 CF + 10 MoS₂ | No | 93 |
| embodiment 3 | | | |
| Comparative | PF + 10 Gr + 5 CF | No | 105 |
| embodiment 4 | | | |

Table 1 shows an abrasion loss of the embodiments 1 to 4 of the rod guide 8 in accordance with the embodiment of the present invention, and the comparative embodiments 1 to 4 of the rod guide in accordance with the prior art, under the same test condition. In particular, the embodiments 1 to 4 are constituted by the rod guide 8 structured by coating the sliding synthetic resin layer 21 having the resin component shown in a left field in Table 1 on the outer surface of the press molded product 20 formed by press molding the sheet material in accordance with an injection molding, and the comparative embodiments 1 to 4 are constituted by the rod guide structured such that an entire of the rod guide is injection molded by the resin component shown in the left field of Table 1. The abrasion loss in each of the embodiments is shown in a right field of Table 1. In this case, the test condition is constituted by a matter that a load is 100 N, a stroke is ±25 mm, a frequency is 2.5 Hz, a number of oscillation is two million times, a temperature is 80° C., a surface of the piston rod is Cr plated, and a surface roughness thereof is equal to or less than Rz 1 μm.

Describing in more detail, when measuring the abrasion loss of the rod guide 8 formed by coating the synthetic resin component constituted by 10 volume % of CF, 5 volume % of PTFE and the residual volume % of PPS on the outer surface of the press molded product 20 in the embodiment 1 in accordance with the injection molding, under the test condition mentioned above, the abrasion loss is 18 μm. In the same manner, in the case of the rod guide 8 formed by coating the synthetic resin component constituted by 5 volume % of whisker, 10 volume % of PTFE and the residual volume % of PEEK on the outer surface of the press molded product 20 in the embodiment 2 in accordance with the injection molding, the abrasion loss is 10 μm. In the case of the rod guide 8 formed by coating the synthetic resin component constituted by 5 volume % of CF, 10 volume % of MoS₂ and the residual volume % of PA on the outer surface of the press molded product 20 in the embodiment 3 in accordance with the injection molding, the abrasion loss is 23 μm. In the case of the rod guide 8 formed by coating the synthetic resin component constituted by 10 volume % of Gr, 5 volume % of CF and the residual volume % of PF on the outer surface of the press molded product 20 in the embodiment 4 in accordance with the injection molding, the abrasion loss is 29 μm.

On the contrary, the comparative embodiments 1 to 4 respectively correspond to the embodiments 1 to 4, and are structured such that the entire of the rod guide is formed by the synthetic resin component used as the sliding synthetic resin layer 21 of the embodiments 1 to 4 in accordance with the injection molding. In the case of the comparative embodiment 1 (the synthetic resin constituted by 10 volume % of CF, 5 volume % of PTFE and the residual volume % of PPS), the abrasion loss is 80 μm, in the case of the comparative embodiment 2 (the synthetic resin constituted by 5 volume % of whisker, 10 volume % of PTFE and the residual volume % of PEEK), the abrasion loss is 51 μm, in the case of the comparative embodiment 3 (the synthetic resin constituted by 5 volume % of CF, 10 volume % of MoS₂ and the residual volume % of PA), the abrasion loss is 93 μm, and in the case of the comparative embodiment 4 (the synthetic resin constituted by 10 volume % of Gr, 5 volume % of CF and the residual volume % of PF), the abrasion loss is 105 μm.

In view of the test results mentioned above, the rod guide in which the entire of the rod guide is injection molded by the same resin component as the sliding synthetic resin layer has an extremely great abrasion loss in comparison with the rod guide 8 in which the sliding synthetic resin layer 21 is coated on the outer surface of the press molded product 20 formed by press molding the sheet material in accordance with the injection molding. This means the following matters. In the comparative embodiments 1 to 4 having no press molded product 20, since the rigidity of the rod guide 8 is weak, it is considered that the abrasion loss is increased due to the deformation caused by a biased contact. On the contrary, in the embodiments 1 to 4 of the present invention having the press molded product 20, since the rigidity can be sufficiently secured, it is possible to inhibit the deformation caused by the biased contact as much as possible, so that it is possible to provide the rod guide 8 having an excellent abrasion resistance. In this case, although Table 1 does not show, the weight of the rod guide 8 shown in the embodiments 1 to 4 can be saved at 40% or more in comparison with the rod guide using the ferrous sintered housing, in accordance with research of the applicant.

TABLE 2

| | | | Thick- | |
|---|---|---|---|---|
| | Sliding synthetic | | ness of | |
| | resin layer | | coating | Abrasion |
| | component | | layer | loss |
| | (volume %) | Weight (g) | (μm) | (μm) |
| Embodiment 1 | PF + 50 Gr coating | 34 | 30 | 13 |
| Embodiment 2 | PAI + 10 MoS₂ + 40 | 34 | | 8 |
| | Gr coating | | | |
| Embodiment 3 | PA + 10 MoS₂ | 34 | | 16 |
| | coating | | | |
| Embodiment 4 | PPS + 20 PTFE | 34 | | 11 |
| | coating | | | |
| Comparative | PTFE + 20 PFA | 36 | — | 10 |
| embodiment 1 | composite member | | | |
| Comparative | PTFE + 20 Pb | 36 | | 15 |
| embodiment 2 | composite member | | | |
| Comparative | PTFE + 20 PFA | 67 | | 9 |
| embodiment 3 | composite member | | | |

Next, Table 2 shows an abrasion loss of the embodiments 1 to 4 of the rod guide 8 in accordance with the embodiment of the present invention, and the comparative embodiments 1 to 3 of the rod guide in accordance with the prior art, under the same test condition. In particular, the embodiments 1 to 4 are constituted by the rod guide 8 structured by coating the sliding synthetic resin layer 21 having the resin component shown in a left field in Table 2 on the outer surface of the press molded product 20 formed by press molding the sheet material in accordance with a spray coating at a coating thickness of 30 μm, and the comparative embodiments 1 and 2 are constituted by the rod guide structured such that the composite resin sliding member constituted by the resin component shown in the left field of Table 2 is pressed into the sliding surface 20a of the press molded product 20 formed by press molding the sheet material, and the comparative embodiment 3 is constituted by the rod guide structured such that the composite resin sliding member constituted by the resin component shown in the left field of Table 2 is pressed into the sliding surface of the ferrous sintered housing. The weight in each of the embodiments is shown in a middle field of Table 2, and the abrasion loss in each of the embodiments is shown in a right field of Table 2. In this case, the test condition is constituted by a matter that a load is 100 N, a stroke is ±25 mm, a frequency is 2.5 Hz, a number of oscillation is two million times, a temperature is 80° C., a surface of the piston rod is Cr plated, and a surface roughness thereof is equal to or less than Rz 1 μm.

Describing in more detail, when measuring the weight and the abrasion loss of the rod guide 8 formed by coating the synthetic resin component constituted by 50 volume % of Gr and the residual volume % of PF on the outer surface of the press molded product 20 in the embodiment 1 in accordance with the spray coating, under the test condition mentioned above, the weight is 34 g, and the abrasion loss is 13 μm. In the same manner, in the case of the rod guide 8 formed by coating the synthetic resin component constituted by 10 volume % of MoS₂, 40 volume % of Gr and the residual volume % of PI on the outer surface of the press molded product 20 in the embodiment 2 in accordance with the spray coating, the weight is 34 g and the abrasion loss is 8 μm. In the case of the rod guide 8 formed by coating the synthetic resin component constituted by 10 volume % of MoS₂ and the residual volume % of PA on the outer surface of the press molded product 20 in the embodiment 3 in accordance with the spray coating, the weight is 34 g and the abrasion loss is 16 μm. In the case of the rod guide 8 formed by coating the synthetic resin component constituted by 20 volume % of PTFE and the residual volume % of PPS on the outer surface of the press molded product 20 in the embodiment 4 in accordance with the spray coating, the weight is 34 g and the abrasion loss is 11 μm.

On the contrary, in accordance with the comparative embodiment 1, when measuring the weight and the abrasion loss of the rod guide formed by pressing the composite resin sliding member coated with the synthetic resin component constituted by 20 volume % of PFA and the residual volume % of PTFE into the sliding surface 20a of the press molded product 20, under the test condition mentioned above, the weight is 36 g, and the abrasion loss is 10 μm. In the same manner, in accordance with the comparative embodiment 2, in the case of the rod guide formed by pressing the composite resin sliding member coated with the synthetic resin component constituted by 20 volume % of Pb and the residual volume % of PTFE into the sliding surface 20a of the press molded product 20 in the same manner, the weight is 36 g and the abrasion loss is 15 μm. Further, in accordance with the comparative embodiment 3, when measuring the weight and the abrasion loss of the rod guide formed by pressing the composite resin sliding member coated with the synthetic resin component constituted by 20 volume % of PFA and the residual volume % of PTFE into the sliding surface of the ferrous sintered housing, under the same test conditions, the weight is 67 g and the abrasion loss is 9 μm.

In view of the test results mentioned above, the rod guide in which the composite resin sliding member is pressed into the sliding surface of the press molded product formed by press molding the sheet material is hardly different with regard to the abrasion loss, and is slightly heavier in the weight, in comparison with the rod guide 8 in accordance with the present embodiment in which the sliding synthetic resin layer 21 is coated on the outer surface of the press molded product 20 formed by press molding the sheet material in accordance with the spray coating. Accordingly, both are hardly different from each other totally, however, the rod guide 8 in accordance with the present embodiment can be easily manufactured in comparison with the rod guide into which the composite resin sliding member is pressed, so that it is possible to reduce a manufacturing cost and it is possible to slightly reduce the weight.

On the other hand, in comparison with the rod guide 8 in accordance with the present embodiment in which the sliding synthetic resin layer 21 is coated on the outer surface of the press molded product 20 formed by press molding the sheet material in accordance with the spray coating, the rod guide in which the composite resin sliding member is pressed into the sliding surface of the ferrous sintered housing, is hardly different in view of the abrasion loss, and has about twice weight. Accordingly, since the rod guide 8 in accordance with the present embodiment can be easily manufactured in comparison with the rod guide in which the composite resin sliding member is pressed into the ferrous sintered housing, it is possible to widely reduce the weight in addition that the manufacturing cost can be reduced.

The description is in detail given above of the embodiment. In accordance with the present embodiment, the rod guide 8 is constituted by the press molded product 20 formed by press molding the sheet material, and at least the sliding surface 20a with the piston rod 5 is coated with the sliding synthetic resin layer 21, in the hydraulic shock absorber 1 having the rod guide 8 which guides the piston rod 5 provided in the end portion of the cylinder 2 and sliding within the cylinder 2. Accordingly, the rod guide 8 is constituted by the press molded product 20 formed by press molding the sheet material, and is structured by coating at least the sliding surface 20a with respect to the piston rod 5 with the sliding synthetic resin layer 21. Therefore, it is possible to achieve a wide weight saving in comparison with the case of using the ferrous sintered housing, it is possible to secure a sufficient rigidity in comparison with the case that the entire of the rod guide is formed by the sliding synthetic resin, and it is possible to achieve a further weight saving in comparison with the structure into which the composite sliding member is pressed.

Further, in accordance with the present embodiment, since the sliding synthetic resin layer 21 is formed by outsert molding the synthetic resin in the press molded product 20, it is possible to easily and inexpensively manufacture the rod guide with resin.

Further, in accordance with the present embodiment, since the sliding synthetic resin layer 21 is formed by coating the sliding synthetic resin on the press molded product 20, it is possible to easily and inexpensively manufacture the rod guide with resin.

In this case, in the embodiment mentioned above, the sheet material constituting the press molded product 20 is exemplified by the SPCD material, however, the sheet material may have any composition as far as the sheet material can be deep drawn. Further, in the base resin of the sliding synthetic resin, any synthetic resin may be employed as far as the synthetic resin is a thermoplastic resin or a thermosetting resin and is used as the sliding synthetic resin.

As is apparent from the above description, in the invention in accordance with the first aspect, the rod guide is constituted by the press molded product formed by press molding the sheet material, and is structured by coating at least the sliding surface with respect to the piston rod with the sliding synthetic resin layer. Accordingly, it is possible to achieve a wide weight saving in comparison with the case that the metal sintered housing is used, it is possible to secure a sufficient rigidity in comparison with the case that the entire of the rod guide is formed by the sliding synthetic resin, and it is possible to achieve a further weight saving in comparison with the structure into which the composite sliding member is pressed.

Further, in the invention in accordance with the second and third aspects, it is possible to easily and inexpensively manufacture the rod guide with resin.

What is claimed is:

1. A hydraulic shock absorber having a rod guide for guiding a piston rod provided in an end portion of a cylinder and sliding within said cylinder, wherein said rod guide is constituted by a press molded product formed by press molding a sheet member, and at least a sliding surface of said rod guide with respect to said piston rod is coated by a sliding synthetic resin layer.

2. A hydraulic shock absorber as claimed in claim 1, wherein said sliding synthetic resin layer is formed by outsert molding the sliding synthetic resin in said press molded product.

3. A hydraulic shock absorber as claimed in claim 1, wherein said sliding synthetic resin layer is formed by coating the sliding synthetic resin on said press molded product.
